(19) United States
(12) Patent Application Publication
(10) Pub. No.: US 2006/0227788 A1
(43) Pub. Date: Oct. 12, 2006

(54) Managing queues of packets

(76) Inventors: Avigdor Eldar, Jerusalem (IL); Moshe Valenci, Givat-Zeev (IL)

Correspondence Address: KONRAD RAYNES & VICTOR, LLP.;ATTN: INT77, 315 SOUTH BEVERLY DRIVE, SUITE 210, BEVERLY HILLS, CA, 90212, US

(21) Appl. No.: 11/093,654

(22) Filed: Mar. 29, 2005

(51) Int. Cl. H04L 12/56; H04L 12/28

(52) U.S. Cl. 370/395.4

(57) ABSTRACT

Provided are a method, system, and article of manufacture for managing queues of packets. Packets are received at a network interface, wherein the received packets are capable of being processed by a plurality of processors. The received packets are stored in memory. Tasks are scheduled corresponding to selected processors of the plurality of processors. The stored packets are concurrently processed via the scheduled tasks.

### BACKGROUND

Receive side scaling (RSS) is a feature in an operating system that allows network adapters that support RSS to direct packets of certain Transmission Control Protocol/Internet Protocol (TCP/IP) flow to be processed on a designated Central Processing Unit (CPU), thus increasing network processing power on computing platforms that have a plurality of processors. Further details of the TCP/IP protocol are described in the publication entitled “Transmission Control Protocol: DARPA Internet Program Protocol Specification,” prepared for the Defense Advanced Projects Research Agency (RFC 793, published September 1981). The RSS feature scales the received traffic across the plurality of processors in order to avoid limiting the receive bandwidth to the processing capabilities of a single processor.

In certain operating systems, a plurality of processors may handle a plurality of Transmission Control Protocol (TCP) connections. In symmetric multiprocessor (SMP) machines the network processing power may be increased if TCP connections are dispatched appropriately. In order to support RSS a network adapter may have to implement an internal dispatching mechanism and a plurality of memory-mapped receive queues that depend on the target platform and the number of processors. Each receive queue may be associated with a different CPU, by a predefined method.

### BRIEF DESCRIPTION OF THE DRAWINGS

Referring now to the drawings in which like reference numbers represent corresponding parts throughout:

FIG. 1 illustrates a computing environment, in accordance with certain embodiments;

FIG. 2 illustrates the concurrent consumption of packets by dispatch handlers in the computing environment of FIG. 1, in accordance with certain embodiments;

FIG. 3 illustrates how an interrupt handler operates in the computing environment of FIG. 1, in accordance with certain embodiments;

FIG. 4 illustrates how a dispatch handler operates in the computing environment of FIG. 1, in accordance with certain embodiments;

FIG. 5 illustrates cache aligned data structures and non-global receive resource pools in the computing environment of FIG. 1, in accordance with certain embodiments;

FIG. 6 illustrates operations for managing packets, in accordance with certain embodiments;

FIG. 7 illustrates a block diagram of a first system corresponding to certain elements of the computing environment, in accordance with certain embodiments; and

FIG. 8 illustrates a block diagram of a second system including certain elements of the computing environment, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Certain embodiments provide a software based solution to dispatch receive queues in RSS, in case the number of CPUs in a host computer exceeds the number or receive queues supported by a network adapter on the host computer.

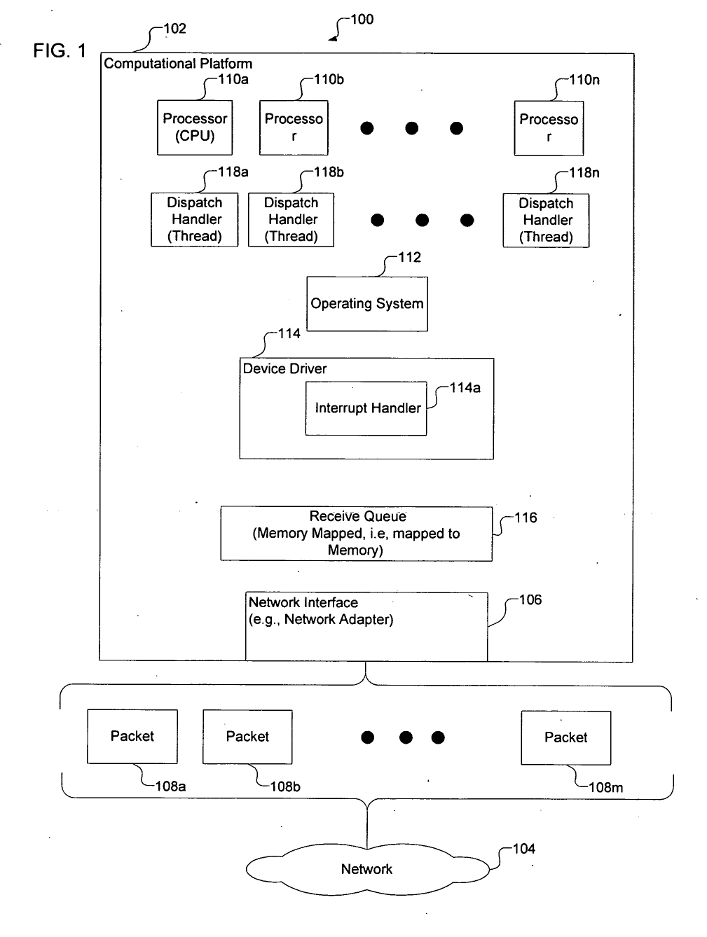

FIG. 1 illustrates a computing environment 100, in accordance with certain embodiments. A computational platform 102 is coupled to a network 104 via a network interface 106. The computational platform 102 may send and receive packets 108a, 108b, . . . 108m from other devices (not shown) through the network 104.

The computational platform 102 may be any suitable device including those presently known in the art, such as, an SMP machine, a personal computer, a workstation, a server, a mainframe, a hand held computer, a palm top computer, a telephony device, a network appliance, a blade computer, a storage server, etc. The network 104 may comprise the Internet, an intranet, a Local area network (LAN), a Storage area network (SAN), a Wide area network (WAN), a wireless network, etc. The network 104 may be part of one or more larger networks or may be an independent network or may be comprised of multiple interconnected networks. The network interface 106 may send and receive packets over the network 104. In certain embodiments the network interface 106 may include a network adapter, such as, a TCP/IP offload engine,(TOE) adapter.

In certain embodiments, the computational platform 102 may comprise a plurality of processors 110a, 110b, . . . , 110n, an operating system 112, a device driver 114 including an interrupt handler 114a, one or more receive queues 116, and a plurality of dispatch handlers 118a, 118b, . . . 118n.

The plurality of processors 110a . . . 110n may comprise Complex Instruction Set Computer (CISC) or Reduced Instruction Set Computer (RISC) processors or any other suitable processor. The operating system 112 may comprise an operating system that is capable of supporting RSS. In certain embodiments, the operating system 112 may comprise the MICROSOFT WINDOWS* operating System, the LNIX* operating system, or other operating system. The device driver 114 may be a device driver for the network interface 106. For example, in certain embodiments if the network interface hardware 106 is a network adapter then the device driver 114 may be a device driver for the network adapter 106.

The network interface 106 receives the plurality of packets 108a . . . 108m and places them in the receive queue 116. In certain embodiments, the receive queue 116 may be implemented in hardware and may be implemented either within or outside the network interface 106. The receive queue 116 may be mapped to the memory (not shown) of the computational platform 102, i.e., the receive queue 116 may be a memory mapped receive queue. The plurality of packets 108a . . . 108m are placed in the receive queue 116 in the order in which the plurality of packets arrive at the network interface 106. In certain embodiments, plurality of processors 110a . . . 110n process packets placed in the receive queue 116.

Although, FIG. 1 shows one receive queue 116, in alternative embodiments there may be more than one receive queue 1 16. The plurality of processors 110a . . . 110n may be divided into groups, where different groups may process packets in different receive queues.

The interrupt handler 114a is an execution thread or process that receives interrupts from the network interface 106 and schedules the one or more dispatch handlers 118a . . . 118n, where a scheduled dispatch handler processes packets for one of the plurality of processors 110a . . . 110n. For example, dispatch handler 118a may process packets for processor 110a, dispatch handler 118b may process packets for processor 110b, and dispatch handler 118n may process packets for processor 110n. In certain embodiments, the plurality of dispatch handlers 118a . . . 118n may be tasks that are capable of executing concurrently. In certain embodiments, a plurality of dispatch handlers can run concurrently and process packets from the same receive queue.

In FIG. 1, the plurality of packets 108a . . . 108m are placed in the receive queue 116 by the network interface 106. The plurality of processors 110a . . . 110n process the plurality of packets 108a . . . 108m concurrently.

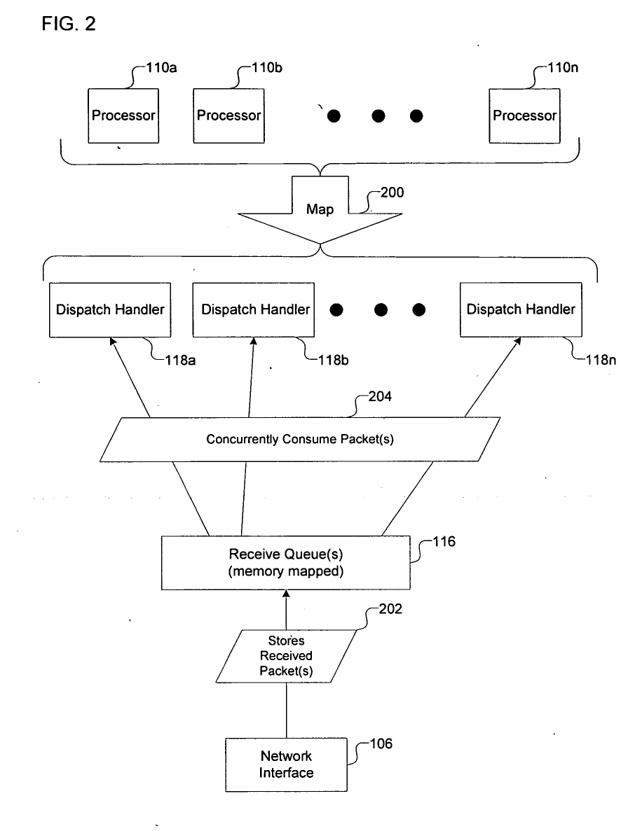

FIG. 2 is a block diagram that illustrates the concurrent consumption of packets by dispatch handlers 118a . . . 118n in the computing environment 100, in accordance with certain embodiments.

The plurality of processors 110a . . . 110n are mapped (at block 200) to the plurality of dispatch handlers 118a . . . 118n. In certain embodiments, for each processor there is a corresponding dispatch handler that executes on the processor.

The network interface 106 stores (at block 202) received packets into the receive queue 116. If the receive queue 116 is a memory mapped receive queue, the packets are stored in the memory of the computational platform 102.

The plurality of dispatch handlers 118a . . . 118n concurrently consume (at block 204) the packets stored in the receive queue 116. For example, in certain exemplary embodiments a first packet stored in the receive queue 116 may be executed by the dispatch handler 118a that executes as a thread on the processor 110a, a second packet stored in the receive queue 116 may be executed by the dispatch handler 118b that executes as a thread on the processor 110b, and a third packet stored in the receive queue 116 may be executed by the dispatch handler 118n that executes as a thread on the processor 118, where the dispatch handlers 118a, 118b, 118n may execute concurrently, i.e., at the same instant of time, in the processors 110a, 110b, 110n.

In an exemplary embodiment illustrated in FIG. 2 a plurality of dispatch handlers 118a . . . 118n correspond to a plurality of processors and concurrently consume packets placed in the receive queue 116 by the network interface 106.

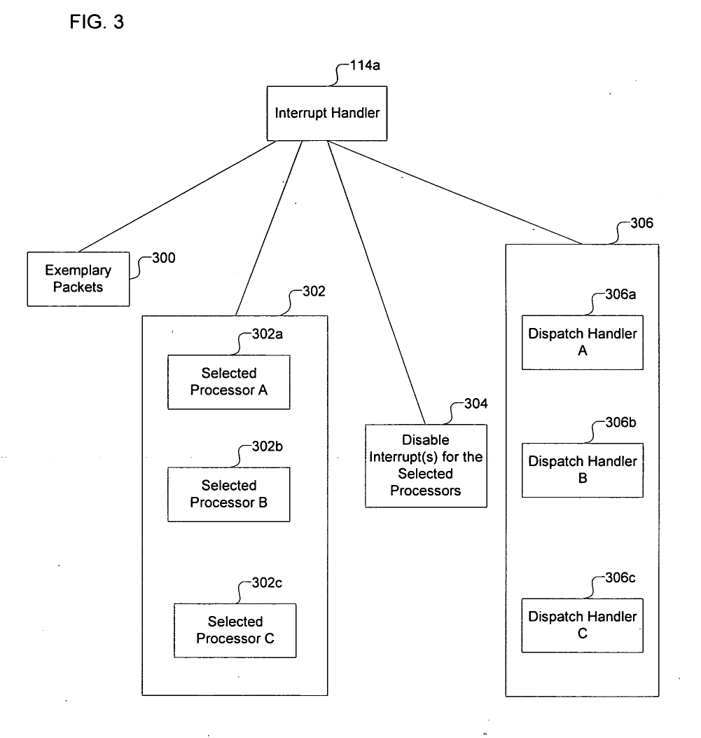

FIG. 3 is a block diagram that illustrates how the interrupt handler 114a operates in the computing environment 100, in accordance with certain embodiments.

The interrupt handler 114a may read a plurality of exemplary packets 300 and determine selected processors 302 that can process the plurality of exemplary packets 300. The selected processors 302 may include some or all of the processors 110a . . . 110n. For example the selected processors 302 may include a selected processor A 302a, a selected processor B 302b, and a selected processor C 302c. While three selected processors 302a, 302b, 302c have been shown in FIG. 3, in alternative embodiments the exemplary packets 300 can be processed by a fewer or a greater number of processors selected from the plurality of processors 110a . . . 110n.

The interrupt handler 114a disables (at block 304) the interrupts associated with the receive queues 116 for the selected processors 302. For example, the interrupt handler 114a may disable the interrupts associated with the receive queues of the selected processors 302a, 302b, 302c. As a result of disabling the interrupts, the selected processors 302 do not respond to requests other than those that correspond to the processing of the plurality of exemplary packets 300.

The interrupt handler 114a schedules dispatch handlers 306 corresponding to the selected processors 302. For example, the interrupt handler 114a may schedule dispatch handler A 306a for execution on selected processor A 302a, dispatch handler B 306b for execution on selected processor B 302b, and dispatch handler C 306c for execution on selected processor C 302c.

In an exemplary embodiment illustrated in FIG. 3 the interrupt handler 114a schedules a plurality of dispatch handlers 306 for execution on selected processors 302 after disabling interrupts corresponding to the receive queue of the selected processors 302. The selected processors 302 process the plurality of exemplary packets 300.

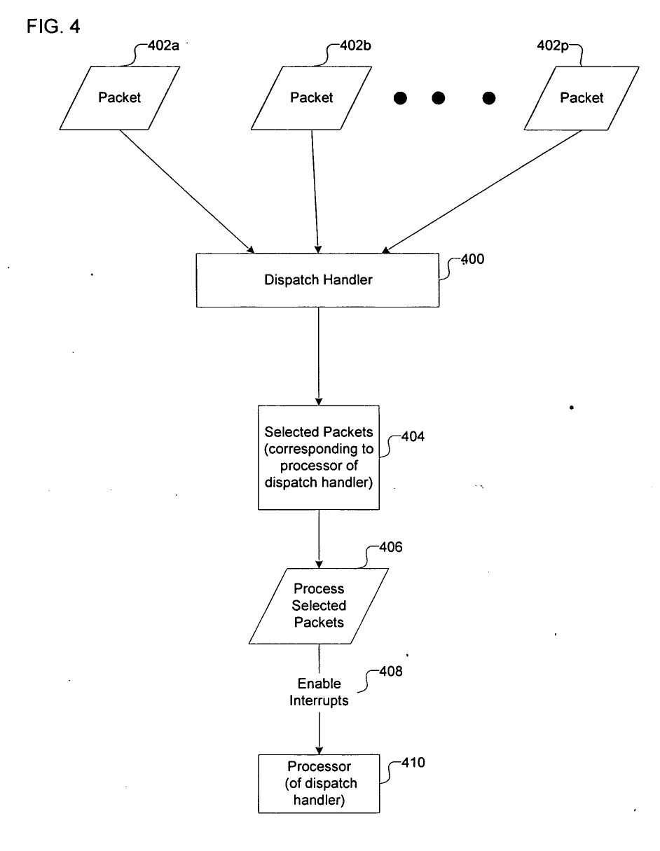

FIG. 4 is a block diagram that illustrates how an exemplary dispatch handler 400 operates in the computing environment 100, in accordance with certain embodiments. In certain embodiments, the exemplary dispatch handler 400 may be any of the dispatch handlers 118a . . . 118n shown in FIG. 1.

The exemplary dispatch handler 400 reads a plurality of packets 402a, 402b, . . . 402p from the memory to which the receive queue 116 has mapped into. The exemplary dispatch handler 400 determines selected packets 404 that can be executed on the processor corresponding to the exemplary dispatch handler 400. For example, if exemplary dispatch handler 400 executes as a thread on processor 110a, and packets 402a, 402p can be executed on the processor 110a, then the selected packets 404 are packets 402a, 402p.

The exemplary dispatch handler 400 processes (at block 406) the selected packets 404 on the processor 410 on which the dispatch handler 400 executes. Subsequently, the exemplary dispatch handler 400 enables (at block 408) the interrupt for the receive queue of the processor 410 on which the dispatch handler 400 executes. The interrupts on the receive queue for the processor 410 had previously been disabled by the interrupt handler 114a when the dispatch handler 400 was scheduled, and the exemplary dispatch handler 400 enables the interrupts for the receive queue of the processor 410 after processing the selected packets 404 on the processor 410.

In an exemplary embodiment illustrated in FIG. 4, a scheduled dispatch handler 400 selects packets corresponding to the processor on which the dispatch handler 400 executes. After processing the selected packets on the processor on which the dispatch handler 400 executes, the dispatch handler 400 enables the interrupts corresponding to the receive queue of the processor.

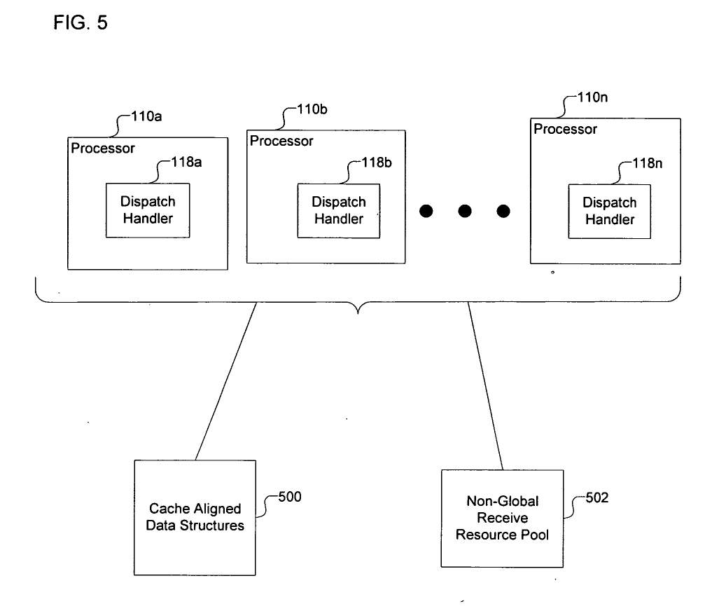

FIG. 5 is a block diagram that illustrates cache aligned data structures 500 and non-global receive resource pools 502 of the computing environment 100, in accordance with certain embodiments.

Since a plurality of dispatch handlers 118a . . . 118n run in parallel on a plurality of processors 110a . . . 110n and use shared memory there is a potential for processor cache thrashing. Certain embodiments reduce the amount of processor cache thrashing by allocating cache-aligned data structures 500. In such embodiments, data structures in processor cache are allocated in a cache-aligned manner. In certain embodiments, the amount of processor cache thrashing is reduced by maintaining a non-global receive resources pool 502, i.e., certain resources associated with the receive queue 116 are not global resources accessible to all processes and threads in the computing platform 102.

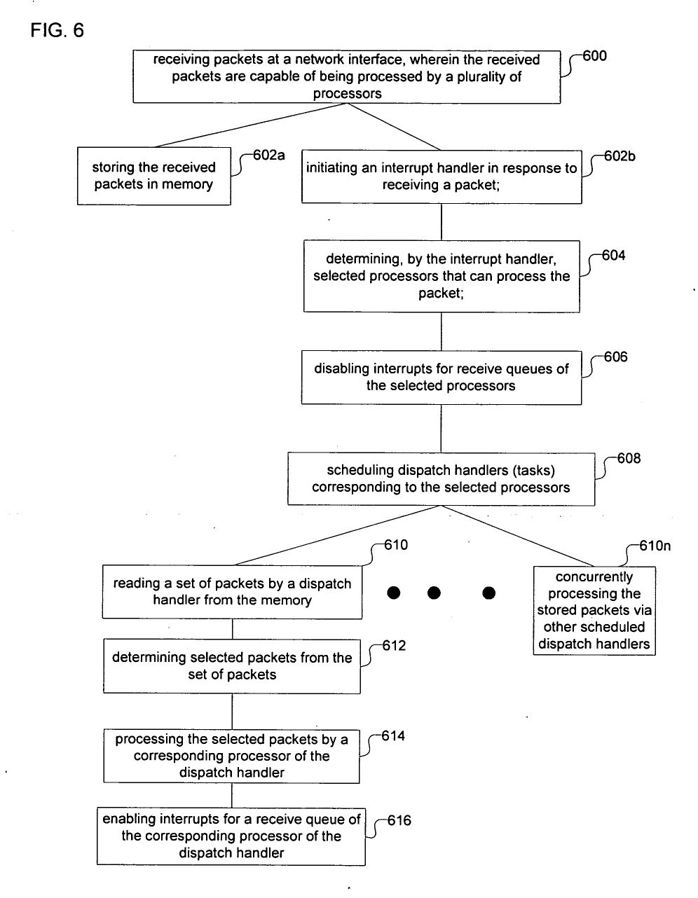

FIG. 6 illustrates operations for managing packets, in accordance with certain embodiments. The operations may be implemented in the computing platform 102 of the computing environment 100.

Control starts at block 600, where a plurality of packets 108a . . . 108m are received at a network interface 106, where the received packets 108a . . . 108m are capable of being processed by some of all of a plurality of processors 110a . . . 110n.

The network interface 108 stores (at block 602a) the received packets in the receive queue 116, where the receive queue 116 is a memory mapped receive queue, i.e., the received packets are stored in the memory of the computational platform 102.

In parallel with the storing (at block 602a) of the received packets, the network interface 108 initiates (at block 602b) an interrupt handler 114a in response to receiving one or more packets. For example, an exemplary network interface 106 may initiate the interrupt handler 114a in the device driver 114 of the network interface 108 after receiving a stream of hundred packets.

The interrupt handler 114a determines (at block 604) selected processors 302 that can process the one or more packets. The interrupt handler 114a disables (at block 606) the interrupts corresponding to the receive queues of the selected processors. The selected processors disregard all requests except those related to packet processing. The interrupt handler 114a schedules (at block 608) a plurality of dispatch handlers 306, i.e., tasks, corresponding to the selected processors.

A scheduled dispatch handler, such as, dispatch handler 400, reads (at block 610) a set of packets from the memory to which the receive queue 116 is mapped into. The scheduled dispatch handler 400 determines (at block 612) selected packets from the set of packets.

The scheduled dispatch handler 400 processes (at block 614) the selected packets by a corresponding processor of the dispatch handler. For example, the scheduled dispatch handler 400 may execute as a thread on processor 110a and process the selected packets on processor 110a. There may be packets other than the selected packets in the set of packets read by the dispatch handler 400 that may be processed by other dispatch handlers scheduled at block 608 by the interrupt handler 114a.

After processing (at block 614) the selected packets, the scheduled dispatch hander 400 enables (at block 616) the interrupts associated with the receive queue for the corresponding processor of the dispatch handler 400. For example, the dispatch handler 400 may enable the interrupts of a receive queue of the processor 110a, where the interrupts of receive queue for the processor 110a had been disabled at block 606 by the interrupt handler 114a.

Concurrently with the processing of packets by the dispatch handler 400 in blocks 610, 612, 614, 616, other dispatch handlers scheduled by the interrupt handler 114a in block 608, process (at block 610n) the stored packets. Therefore, a plurality of dispatch handlers 118a. . . 118n can concurrently process packets stored in a receive queue 116, where the plurality of dispatch handlers 118a . . . 118n execute on the plurality of processors 110a . . . 110n.

In an exemplary embodiment illustrated in FIG. 6, an interrupt handler 114a schedules a plurality of dispatch handlers 118a . . . 118n for concurrently processing a plurality of packets 108a . . . 108m stored in a receive queue 116 by a network interface 106. The dispatch handlers 118a . . . 118n executed on a plurality of processors 110a . . . 110n, and the plurality of received packets 108a . . . 108m are executed concurrently on the plurality of processors 110a . . . 110n.

Certain embodiments allow the number of processors to be more than the number of receive queues in an RSS environment. The packets placed in a receive queue corresponding to a plurality of processors are processed concurrently by the plurality of processors.

Certain embodiments reduce the network traffic latency by parallel processing of received packets. Certain embodiments can be implemented in software and the concurrent processing of packets in the software implemented dispatch handlers eliminate the need to have a hardware receive queue corresponding to each processor.

The described techniques may be implemented as a method, apparatus or article of manufacture involving software, firmware, micro-code, hardware and/or any combination thereof. The term “article of manufacture” as used herein refers to program instructions, code and/or logic implemented in circuitry [e.g., an integrated circuit chip, Programmable Gate Array (PGA), Application Specific Integrated Circuit (ASIC), etc.] and/or a computer readable medium (e.g., magnetic storage medium, such as hard disk drive, floppy disk, tape), optical storage (e.g., CD-ROM, DVD-ROM, optical disk, etc.), volatile and non-volatile memory device (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.). Code in the computer readable medium may be accessed and executed by a machine, such as, a processor. In certain embodiments, the code in which embodiments are made may further be accessible through a transmission medium or from a file server via a network. In such cases, the article of manufacture in which the code is implemented may comprise a transmission medium, such as a network transmission line, wireless transmission media, signals propagating through space, radio waves, infrared signals, etc. Of course, those skilled in the art will recognize that many modifications may be made without departing from the scope of the embodiments, and that the article of manufacture may comprise any information bearing medium known in the art. For example, the article of manufacture comprises a storage medium having stored therein instructions that when executed by a machine results in operations being performed. Furthermore, program logic * that includes code may be implemented in hardware, software, firmware or any combination thereof. The described operations of FIGS. 2, 3, 4, 5 may be performed by circuitry, where “circuitry” refers to either hardware or software or a combination thereof. The circuitry for performing the operations of the described embodiments may comprise a hardware device, such as an integrated circuit chip, a PGA, an ASIC, etc. The circuitry may also comprise a processor component, such as an integrated circuit, and code in a computer readable medium, such as memory, wherein the code is executed by the processor to perform the operations of the described embodiments.

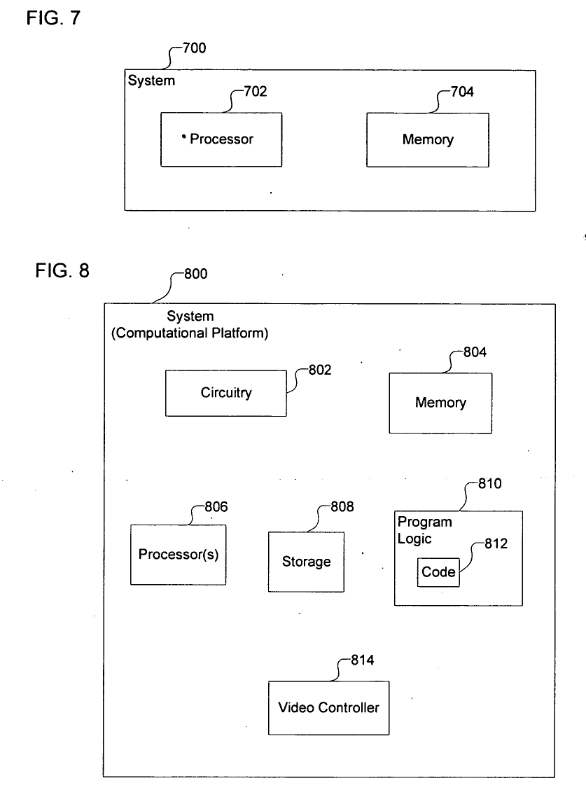

Certain embodiments illustrated in FIG. 7 may implement a system 700 comprising processor 702 coupled to a memory 704, wherein the processor 702 is operable to perform the operations described in FIGS. 2, 3, 4, 5.

FIG. 8 illustrates a block diagram of a system 800 in which certain embodiments may be implemented. Certain embodiments may be implemented in systems that do not require all the elements illustrated in the block diagram of the system 800. The system 800 may include circuitry 802 coupled to a memory 804, wherein the described operations of FIGS. 2, 3, 4, 5 may be implemented by the circuitry 802. In certain embodiments, the system 800 may include a processor 806 and a storage 808, wherein the storage 808 may be associated with program logic 810 including code 812, that may be loaded into the memory 804 and executed by the processor 806. In certain embodiments the program logic 810 including code 812 is implemented in the storage 808. In certain embodiments, the operations performed by program logic 810 including code 812 may be implemented in the circuitry 802. Additionally, the system 800 may also include a video controller 814. The operations described in FIGS. 2, 3, 4, 5 may be performed by the system 800.

Certain embodiments may be implemented in a computer system including a video controller 814 to render information to display on a monitor coupled to the system 800, where the computer system may comprise a desktop, workstation, server, mainframe, laptop, handheld computer, etc. An operating system may be capable of execution by the computer system, and the video controller 814 may render graphics output via interactions with the operating system. Alternatively, some embodiments may be implemented in a computer system that does not include a video controller, such as a switch, router, etc. Furthermore, in certain embodiments the device may be included in a card coupled to a computer system or on a motherboard of a computer system.

Certain embodiments may be implemented in a computer system including a storage controller, such as, a Small Computer System Interface (SCSI), AT Attachment Interface (ATA), Redundant Array of Independent Disk (RAID), etc., controller, that manages access to a non-volatile storage device, such as a magnetic disk drive, tape media, optical disk, etc. Certain alternative embodiments may be implemented in a computer system that does not include a storage controller, such as, certain hubs and switches.

At least certain of the operations of FIGS. 2-5 can be performed in parallel as well as sequentially. In alternative embodiments, certain of the operations may be performed in a different order, modified or removed. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-8 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

MICROSOFT WINDOWS is a trademark of Microsoft Corp.

UNIX is a trademark of the Open Group.

What is claimed is:

1. A method, comprising:
receiving packets at a network interface, wherein the received packets are capable of being processed by a plurality of processors;
storing the received packets in memory;
scheduling tasks corresponding to selected processors of the plurality of processors; and
concurrently processing the stored packets via the scheduled tasks.

2. The method of claim 1, wherein the tasks are dispatch handlers, the method further comprising:
initiating an interrupt handler in response to receiving a packet;
determining, by the interrupt handler, the selected processors that can process the packet; and
disabling interrupts for receive queues of the selected processors prior to the scheduling of the dispatch handlers corresponding to the selected processors.

3. The method of claim 2, the method further comprising:
reading a set of packets, by a dispatch handler, from the memory;
determining selected packets from the set of packets;
processing the selected packets by a corresponding processor of the dispatch handler; and
enabling interrupts for a receive queue of the corresponding processor of the dispatch handler.

4. The method of claim 1, the method further comprising:
disabling interrupts for receive queues of the selected processors; and
enabling interrupts for a receive queue for a selected processor corresponding to a scheduled task, subsequent to processing selected packets via the scheduled task.

5. The method of claim 1, wherein an operating system that executes on the plurality of processors supports receive side scaling, and wherein the received packets are stored in at least one receive queue that is mapped to the memory.

6. The method of claim 5, wherein the tasks are dispatch handlers, wherein the plurality of processors are greater in number than the at least one receive queue, and wherein the dispatch handlers can run concurrently and process a plurality of packets from the at least one receive queue.

7. The method of claim 1, wherein cache aligned data structures are coupled to the plurality of processors for the concurrent processing of the stored packets.

8. The method of claim 1, wherein the network interface is a network adapter, wherein the plurality of processors comprise a symmetric multiprocessor machine, wherein the receiving and the storing are performed by the network adapter, wherein the scheduling of the tasks is performed by a device driver corresponding to the network adapter, and wherein different tasks execute on different processors.

9. A system, comprising:
a memory;
a network interface coupled to the memory; and
a plurality of processors coupled to the memory, wherein at least one processor of the plurality of processors is operable to:
(i) receive packets at the network interface, wherein the received packets are capable of being processed by the plurality of processors;
(ii) store the received packets in the memory;
(iii) schedule tasks corresponding to selected processors of the plurality of processors; and
(iv) concurrently process the stored packets via the scheduled tasks.

10. The system of claim 9, wherein the tasks are dispatch handlers, and wherein the at least one processor is further operable to:
initiate an interrupt handler in response to receiving a packet;
determine, by the interrupt handler, the selected processors that can process the packet; and
disable interrupts for receive queues of the selected processors prior to scheduling the dispatch handlers corresponding to the selected processors.

11. The system of claim 10, wherein the at least one processor is further operable to:
read a set of packets, by a dispatch handler, from the memory;
determine selected packets from the set of packets;
process the selected packets by a corresponding processor of the dispatch handler; and
enable interrupts for a receive queue of the corresponding processor of the dispatch handler.

12. The system of claim 9, wherein the at least one processor is further operable to:
disable interrupts for receive queues of the selected processors; and
enable interrupts for a receive queue for a selected processor corresponding to a scheduled task, subsequent to processing selected packets via the scheduled task.

13. The system of claim 9, further comprising:
an operating system that is capable of execution on the plurality of processors, wherein the operating system supports receive side scaling, and wherein the received packets are stored in at least one receive queue that is mapped to the memory.

14. The system of claim 13, wherein the tasks are dispatch handlers, wherein the plurality of processors are greater in number than the at least one receive queue, and wherein the dispatch handlers can run concurrently and process a plurality of packets from the at least one receive queue.

15. The system of claim 9, wherein cache aligned data structures are coupled to the plurality of processors for the concurrent processing of the stored packets.

16. The system of claim 9, wherein the network interface is a network adapter, wherein the plurality of processors comprise a symmetric multiprocessor machine, wherein the receiving and the storing are performed by the network adapter, wherein the scheduling of the tasks is performed by a device driver corresponding to the network adapter, and wherein different tasks execute on different processors.

17. A system, comprising:
a memory;
a video controller coupled to the memory, wherein the video controller renders graphics output;
a network interface coupled to the memory; and
a plurality of processors coupled to the memory, wherein at least one processor of the plurality of processors is operable to:
(i) receive packets at the network interface, wherein the received packets are capable of being processed by the plurality of processors;
(ii) store the received packets in the memory;
(iii) schedule tasks corresponding to selected processors of the plurality of processors; and
(iv) concurrently process the stored packets via the scheduled tasks.

18. The system of claim 17, wherein the tasks are dispatch handlers, and wherein the at least one processor is further operable to:
initiate an interrupt handler in response to receiving a packet;
determine, by the interrupt handler, the selected processors that can process the packet; and
disable interrupts for receive queues of the selected processors prior to scheduling the dispatch handlers corresponding to the selected processors.

19. The system of claim 18, wherein the at least one processor is further operable to:
read a set of packets, by a dispatch handler, from the memory;
determine selected packets from the set of packets;
process the selected packets by a corresponding processor of the dispatch handler; and
enable interrupts for a receive queue of the corresponding processor of the dispatch handler.

20. The system of claim 17, wherein the network interface is a network adapter, wherein the plurality of processors comprise a symmetric multiprocessor machine, wherein the receiving and the storing are performed by the network adapter, wherein the scheduling of the tasks is performed by a device driver corresponding to the network adapteri and wherein different tasks execute on different processors

21. An article of manufacture, comprising a storage medium having stored therein instructions capable of being executed by a machine to:
receive packets at a network interface, wherein received packets are capable of being processed by a plurality of processors;
store the received packets in memory;
schedule tasks corresponding to selected processors of the plurality of processors; and
concurrently process the stored packets via the scheduled tasks.

22. The article of manufacture of claim 21, wherein the tasks are dispatch handlers, wherein the instructions are further capable of being executed by the machine to:
initiate an interrupt handler in response to receiving a packet;
determine, by the interrupt handler, the selected processors that can process the packet; and
disable interrupts for receive queues of the selected processors prior to scheduling the dispatch handlers corresponding to the selected processors.

23. The article of manufacture of claim 22, wherein the instructions are further capable of being executed by the machine to:
read a set of packets, by a dispatch handler, from the memory;
determine selected packets from the set of packets;
process the selected packets by a corresponding processor of the dispatch handler; and
enable interrupts for a receive queue of the corresponding processor of the dispatch handler.

24. The article of manufacture of claim 21, wherein the instructions are further capable of being executed by the machine to:
disable interrupts for receive queues of the selected processors; and
enable interrupts for a receive queue for a selected processor corresponding to a scheduled task, subsequent to processing selected packets vi, the scheduled task.

25. The article of manufacture of claim 21, wherein an operating system that executes on the plurality of processors supports receive side scaling, and wherein the received packets are stored in at least one receive queue that is mapped to the memory.

26. The article of manufacture of claim 25, wherein the tasks are dispatch handlers, wherein the plurality of processors are greater in number than the at least one receive queue, and wherein the dispatch handlers can run concurrently and process a plurality of packets from the at least one receive queue.

27. The article of manufacture of claim 21, wherein cache aligned data structures are coupled to the plurality of processors for the concurrent processing of the stored packets.

28. The article of manufacture of claim 21, wherein the network interface is a network adapter, wherein the plurality of processors comprise a symmetric multiprocessor machine, wherein the receiving and the storing are performed by the network adapter, wherein the scheduling of the tasks is performed by a device driver corresponding to the network adapter, and wherein different tasks execute on different processors.
